(19) United States
(12) Patent Application Publication
(10) Pub. No.: US 2025/0294592 A1
(43) Pub. Date: Sep. 18, 2025

(54) SYSTEMS AND METHODS FOR ENABLING SIDELINK TRANSMISSIONS IN DOWNLINK SLOTS

(71) Applicant: Samsung Electronics Co., Ltd., Suwon-si (KR)

(72) Inventors: Yaser Mohamed Mostafa Kamal FOUAD, San Diego, CA (US); Mohamed AWADIN, San Diego, CA (US); Philippe Jean Marc Michel SARTORI, Naperville, IL (US)

(21) Appl. No.: 19/075,711

(22) Filed: Mar. 10, 2025

Related U.S. Application Data
(60) Provisional application No. 63/565,457, filed on Mar. 14, 2024.

(51) Int. Cl. H04W 72/25; H04L 25/02; H04L 27/26; H04W 72/23

(52) U.S. Cl. CPC H04W 72/25; H04L 25/0224; H04L 27/2656; H04W 72/23

(57) ABSTRACT

A system and a method are disclosed for performing sidelink communications. The method includes determining, by a user equipment (UE), based on a priority metric satisfying a first threshold and/or a channel-congestion metric satisfying a second threshold, that a first downlink slot within a subset of downlink slots is a candidate for a first sidelink transmission, and performing, by the UE, the first sidelink transmission in the first downlink slot based on one or more transmission parameters, the transmission parameters being pre-configured or indicated to the UE.

### CROSS-REFERENCE TO RELATED APPLICATION

This application claims the priority benefit under 35 U.S.C. § 119(c) of U.S. Provisional Application No. 63/565,457, filed on Mar. 14, 2024, the disclosure of which is incorporated by reference in its entirety as if fully set forth herein.

### TECHNICAL FIELD

The disclosure generally relates to communications. More particularly, the subject matter disclosed herein relates to improvements to systems and methods for sidelink (SL) communications.

### SUMMARY

In New Radio (NR) sidelink (SL) design, SL transmissions may be restricted in (e.g., limited to) uplink (UL) slots only. As used herein, a “sidelink transmission” or “SL transmission” refers to a transmission that is sent from (e.g., sent directly from) one UE to another UE, as opposed to a downlink (DL) transmission, which is sent from a base station to a UE, and as opposed to an uplink transmission, which is sent from a UE to a base station. When SL information is limited to being transmitted in only UL slots, the SL throughput may be degraded, and the latency may be increased due to potential bottlenecks caused by a limited availability of transmission slots for SL information. These disadvantages may be reduced (e.g., may be overcome) if SL transmissions are allowed in DL slots as well (e.g., allowed in both DL slots and UL slots). To allow for SL transmissions in DL slots as well as UL slots, an SL resource pool configuration may be updated, such that the SL resource pool configuration can incorporate DL slots. A network node (e.g., a gNB), or the sidelink UE to perform the SL transmission, may then be able to schedule SL transmission in DL slots (e.g., based on scheduling via DCI signaling). For example, there are two modes of operation for SL transmissions. In Mode 1, resources (e.g., all the resources) are scheduled by the gNB by using radio resource control (RRC) configuration and/or downlink control information (DCI). In mode 2, a UE may perform sensing and detect future reservations of its neighbors and, accordingly, select resources for an upcoming transmission such that the selected resources try to avoid colliding with other UEs (e.g., the resources may be selected, by the UE, to try to avoid colliding with resources used by other UEs).

Additionally, the legacy SL frame structure may cause interference to neighboring UEs (e.g., neighbor regular UEs) receiving DL transmissions in the same DL slot as an SL transmission. The impact of this interference may be more pronounced when an SL transmission, either SL data or a SL demodulation reference signal (DMRS), collides with a DL DMRS.

Aspects of some embodiments of the present disclosure provide for systems and methods to minimize such detrimental impact on the DL channel/signal of the neighboring UEs when a DL slot is used for both DL and SL transmissions.

Furthermore, in legacy specifications, there are no available procedures to handle the collision between different DL reception and SL transmission (e.g., when a sidelink UE is supposed to receive a DL transmission and to perform a sidelink transmission simultaneously in the same slot). For example, the behavior of an SL UE is not defined for when a semi-persistent scheduling (SPS) physical downlink shared channel (PDSCH) collides with an occasion for SL transmission.

Aspects of some embodiments of the present disclosure provide solutions for handling collisions between SL transmissions and DL receptions for the same SL UE in the same DL slots. Aspects of some embodiments of the present disclosure provide for systems and methods to minimize the impact of, and/or to avoid, collisions between DL transmissions and SL transmissions associated with the same downlink slots.

According to some embodiments of the present disclosure, a method for performing sidelink communications includes determining, by a user equipment (UE), based on a priority metric satisfying a first threshold and/or a channel-congestion metric satisfying a second threshold, that a first downlink slot within a subset of downlink slots is a candidate for a first sidelink transmission, and performing, by the UE, the first sidelink transmission in the first downlink slot based on one or more transmission parameters, the transmission parameters being pre-configured or indicated to the UE.

The determining of the priority metric satisfying the first threshold and/or the channel-congestion metric satisfying the second threshold may include at least one of determining that communications associated with the UE qualify as ultra-reliable low latency communications (URLLC) traffic based on a pre-configured threshold indicated to the UE determining that the UE is of a source type associated with safety-related communications, or determining that an occupancy of uplink slots accessible to the UE satisfies an occupancy threshold.

The method may further include performing, by the UE or a second UE, a sidelink channel estimation for the first sidelink transmission based on a puncturing pattern indicating a subset of resource elements to be excluded from use for sidelink transmissions, the puncturing pattern may be indicated by a bitmap or may be pre-configured.

The method may further include performing, by the UE or a second UE, a sidelink channel estimation, for the first sidelink transmission, with an altered pattern or density of a sidelink demodulation reference signal (SL DMRS) to avoid collisions with a downlink reference signal (DL RS).

The method may further include determining that the subset of downlink slots is accessible to the UE for performing the first sidelink transmission by receiving, by the UE, a time division duplex (TDD) configuration indicating that the subset of downlink slots is available for performing the first sidelink transmission.

The method may further include receiving, by the UE, a time division duplex (TDD) configuration, and determining, by the UE, that only uplink slots are accessible to the UE for performing a second sidelink transmission.

A first transmission parameter of the one or more transmission parameters may differ from a second transmission parameter of the second sidelink transmission.

The first transmission parameter may indicate a limitation on a maximum transmit power of the UE.

The method may further include performing, by the UE or a second UE, a signal strength measurement, the performing of the first sidelink transmission may be scheduled on resources that are selected based on the signal strength measurement.

The method may further include performing, by the UE, a channel-estimation procedure based on a sidelink demodulation reference signal (SL DMRS) pattern.

The method may further include determining that the subset of downlink slots is accessible to the UE for performing the first sidelink transmission by determining that the first sidelink transmission has a higher priority than a first downlink transmission scheduled for the first downlink slot.

The determining that the first sidelink transmission has the higher priority than the first downlink transmission may include determining, by the UE, a first measured metric based on at least one previous sidelink transmission, determining, by the UE, a second measured metric based on at least one previous downlink transmission, and determining that the first measured metric is higher than the second measured metric.

The determining of the first measured metric and the determining of the second measured metric may be performed based on determining that both the first sidelink transmission and the first downlink transmission have priorities satisfying a threshold.

The first measured metric and/or the second measured metric may be measured based on a measurement window associated with the first downlink slot.

According to other embodiments of the present disclosure, a system for performing sidelink communications includes a UE, the UE being configured to perform determining, based on a priority metric satisfying a first threshold and/or a channel-congestion metric satisfying a second threshold, that a first downlink slot within a subset of downlink slots is a candidate for a first sidelink transmission, and the first sidelink transmission in the first downlink slot based on one or more transmission parameters, the one or more transmission parameters being pre-configured or indicated to the UE.

The determining of the priority metric satisfying the first threshold and/or the channel-congestion metric satisfying the second threshold may include at least one of determining that communications associated with the UE qualify as ultra-reliable low latency communications (URLLC) traffic based on a pre-configured threshold indicated to the UE, determining that the UE is of a source type associated with safety-related communications, or determining that an occupancy of uplink slots accessible to the UE satisfies an occupancy threshold.

The UE may be configured to perform a sidelink channel estimation for the first sidelink transmission based on a puncturing pattern indicating a subset of resource elements to be excluded from use for sidelink transmissions, the puncturing pattern may be indicated by a bitmap or is pre-configured.

The UE may be configured to perform a sidelink channel estimation, for the first sidelink transmission, with an altered pattern or density of a sidelink demodulation reference signal (SL DMRS) to avoid collisions with a downlink reference signal (DL RS).

The UE may be configured to perform determining that the subset of downlink slots is accessible to the UE for performing the first sidelink transmission by receiving, by the UE, a time division duplex (TDD) configuration indicating that the subset of downlink slots is available for performing the first sidelink transmission.

According to other embodiments of the present disclosure, a device for performing sidelink communications includes a processing circuit, and a memory communicatively connected to the processing circuit, wherein the memory stores instructions that, based on being executed by the processing circuit, cause the processing circuit to perform determining, based on a priority metric satisfying a first threshold and/or a channel-congestion metric satisfying a second threshold, that a first downlink slot within a subset of downlink slots is a candidate for a first sidelink transmission, and the first sidelink transmission in the first downlink slot based on one or more transmission parameters, the one or more transmission parameters being pre-configured or indicated to the device.

### BRIEF DESCRIPTION OF THE DRAWING

In the following section, the aspects of the subject matter disclosed herein will be described with reference to exemplary embodiments illustrated in the figures.

FIG. 1A is a block diagram depicting a system including a UE and a network node for performing sidelink communications, according to some embodiments of the present disclosure.

FIG. 1B is a block diagram depicting a system including half-duplex UEs and a network node in a scenario for performing sidelink communications, according to some embodiments of the present disclosure.

FIG. 2A is a block diagram depicting a sidelink frame structure having a slot format with feedback.

FIG. 2B is a block diagram depicting a sidelink frame structure having a slot format without feedback.

FIG. 3A is a block diagram depicting a modified use of a time division duplex (TDD) configuration that indicates UL/DL slots that are accessible to UEs for SL communications, according to some embodiments of the present disclosure.

FIG. 3B is a diagram depicting a network node (e.g., a gNB or gNodeB) indicating accessibility of DL slots for SL transmissions, according to some embodiments of the present disclosure.

FIG. 3C is a diagram depicting a method for determining SL scheduling based on signal strength measurements, according to some embodiments of the present disclosure.

FIG. 4 is a block diagram depicting reserved SL resource elements within a SL frame structure FS to avoid collisions with DL RS, according to some embodiments of the present disclosure.

FIGS. 5A, 5B, and 5C (collectively, FIG. 5) are block diagrams depicting a shifting of the SL DMRS, according to some embodiments of the present disclosure.

FIG. 6 is a block diagram depicting a method for modifying a sidelink transmission in a DL slot, according to some embodiments of the present disclosure.

FIG. 7 is a diagram depicting a periodic or a semi-persistent modification of SL in DL slots in a particular SL subchannel, according to some embodiments of the present disclosure.

FIG. 8 is a flowchart depicting example operations of a method for determining a prioritization between sidelink and downlink transmissions, according to some embodiments of the present disclosure.

FIG. 9 is a block diagram of an electronic device in a network environment, according to some embodiments of the present disclosure.

FIG. 10 is a flowchart depicting example operations of a method for performing sidelink communications, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In New Radio (NR) Release 16 and Release 17 (Rel-16/Rel-17), many potential sidelink applications were hindered by the limited throughput available for sidelink transmissions. For example, sharing raw sensing information between neighboring vehicles (e.g., a critical application to enable fully autonomous vehicles) may be limited due to the stringent latency and throughput requirements. Hence, the focus of NR Release 18 (Rel-18) was to increase the throughput by increasing the accessible bandwidth for sidelink transmissions. For example, NR Rel-18 focused on enabling carrier aggregation, sidelink transmissions in unlicensed spectrum, sidelink transmissions using frequency range 2 (FR2), and coexistence between NR and LTE in the LTE spectrum.

Despite the advantages of the above approaches, these approaches might still not be sufficient to enable the sharing of raw sensor information between vehicles. For example, sidelink transmissions in unlicensed spectrum and coexistence in LTE spectrum, in some cases, may not be able to meet the stringent latency and reliability requirements. In addition, transmissions in FR2 might suffer from limited range due to high-pass loss. A better approach may be to increase the available resources for NR transmissions within the licensed bandwidth (e.g., within the licensed sub-6 GHz bandwidth). This may be realized by increasing the number of accessible slots for sidelink transmissions. For example, in NR Rel-18, all sidelink transmissions are transmitted only in UL slots, which may significantly limit the number of available slots for transmission within a subframe. This limitation, of transmitting sidelink transmissions only in uplink slots, may protect DL transmissions from neighboring sidelink transmissions. For example, when sidelink transmissions are scheduled autonomously by the device, and are not scheduled by a base station (e.g., when operating in Mode 2), transmitting sidelink transmissions only in uplink slots may protect DL transmissions from neighboring sidelink transmissions. In SL communications, there are two main scheduling modes. In Mode 1, UEs are under network-node coverage (e.g., gNB coverage) and all sidelink transmissions are scheduled by the network node. In Mode 2, UEs may or may not be under network-node coverage and all sidelink transmissions may not be scheduled by the network node 110.

Methods for sidelink transmissions in DL slots are being studied by the 3^{rd} Generation Partnership Project (3GPP) for use in ambient internet of things (A-IoT) systems. For example, in the 3GPP NR Release 19 (Rel-19) A-IoT study item, the following was considered: “Transmission from Ambient IoT device (including backscattering when used) can occur at least in UL spectrum.”

In this 3GPP study item, A-IoT device transmissions may originate from an A-IoT device and may be transmitted on the sidelink towards a neighboring intermediate node. Similarly, an intermediate node may perform a sidelink transmission towards a neighboring A-IoT device. In this 3GPP study item, the possibility of sidelink transmissions by A-IoT devices in DL slots is being considered. The consideration of sidelink transmissions in DL slots is motivated, in part, by the low transmission power of A-IoT devices. For example, because A-IoT devices have low transmission power, a sidelink transmission from an A-IoT device in a DL slot would cause less interference, to be incurred by neighboring DL transmissions on the access (Uu) link, than devices having higher transmission power.

Aspects of some embodiments of the present disclosure provide for systems and methods for enabling sidelink transmissions in DL slots. For example, aspects of some embodiments provide techniques to enable Mode 1 and Mode 2 resource selections for SL transmissions in DL slots. Aspects of some embodiments provide an updated sidelink slot structure that may reduce the interference impact of sidelink transmissions on DL reference signals. Aspects of some embodiments provide a priority-based procedure to handle collisions between sidelink and DL transmissions to and from the same user equipment (UE).

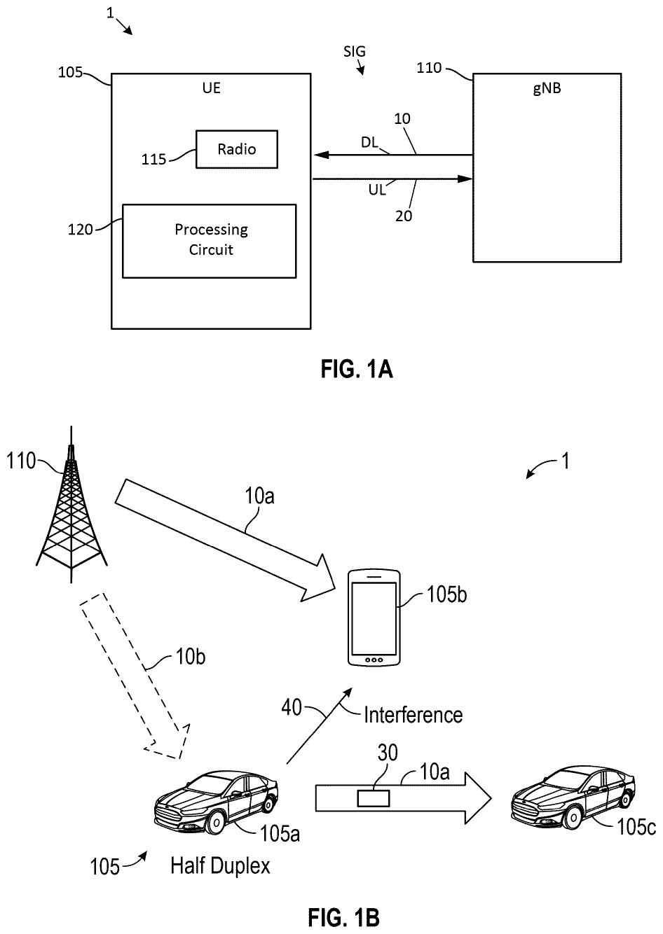

FIG. 1A is a block diagram depicting a system 1 including a UE 105 and a network node 110 for performing sidelink communications, according to some embodiments of the present disclosure.

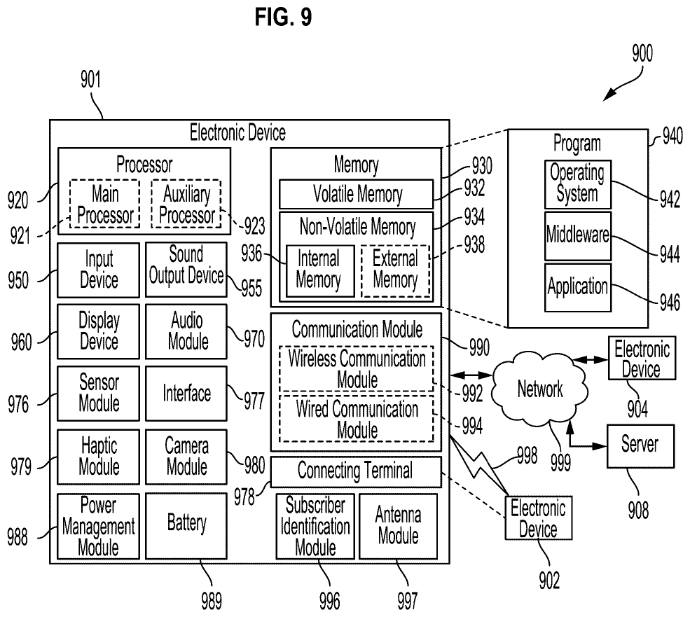

Referring to FIG. 1A, the system 1 for performing sidelink communications may include one or more base stations 110 (e.g., one or more network nodes also referred to as gNBs) and one or more UEs 105. In some embodiments, each of the devices may be capable of receiving DL transmissions 10 from the other devices and may be capable of sending UL transmissions 20 to the other devices. A given UE 105 may include a radio 115 and a means for processing. The means for processing may include a processing circuit 120, which may perform various methods disclosed herein. The radio 115 may correspond to the communication module 990 (see FIG. 9). The processing circuit 120 may correspond to the processor 920 (see FIG. 9). As used herein, the term “UE” is used broadly to refer to electronic communications devices. For example, UEs may include computers, mobile phones, tablets, vehicles, satellites, IoT devices, A-IoT devices, and/or the like.

FIG. 1B is a block diagram depicting a system 1 including half-duplex UEs 105 and a network node 110 in a scenario for performing sidelink communications, according to some embodiments of the present disclosure.

Referring to FIG. 1B, a half-duplex UE 105 (e.g., a half-duplex vehicular UE (vUE)) is a UE (e.g., a UE 105a) that is not expected to receive a DL transmission (e.g., a DL transmission 10b) and transmit sidelink information 30 to a neighboring UE (e.g., a UE 105b or 105c), simultaneously. However, the half-duplex UE 105 may be allowed to perform SL transmissions in DL slots in which it is not expected to receive. For example, the UE 105a may send the sidelink information 30, carried on a DL transmission 10a, to the neighboring UE 105c at a time when the UE 105a is not scheduled to receive any DL transmissions (e.g., when the UE 105a is not scheduled to receive the DL transmission 10b). This is because the interference 40 generated by the UE 105a transmitting the sidelink information 30 to the neighboring UE 105c would not significantly impact the DL transmission 10a received by the neighboring UE 105b. However, the interference 40 generated by the UE 105a transmitting the sidelink information 30 to the neighboring UE 105c would significantly impact the DL transmission 10b if received by the UE 105a simultaneously with the transmission of the sidelink information 30.

This scenario, of allowing half-duplex UEs 105 to perform SL transmissions in DL slots in which they are not expected to receive, may improve (e.g., may significantly improve) the throughput for sidelink transmission, as well as reduce the latency by allowing more slots per subframe to be used for sidelink transmissions. Aspects of embodiments of the present disclosure provide for systems and methods to allow a half-duplex UE 105 (e.g., a vUE) to correctly handle potential collisions between sidelink and downlink transmissions, when performing SL transmissions in DL slots.

### Sidelink Structure

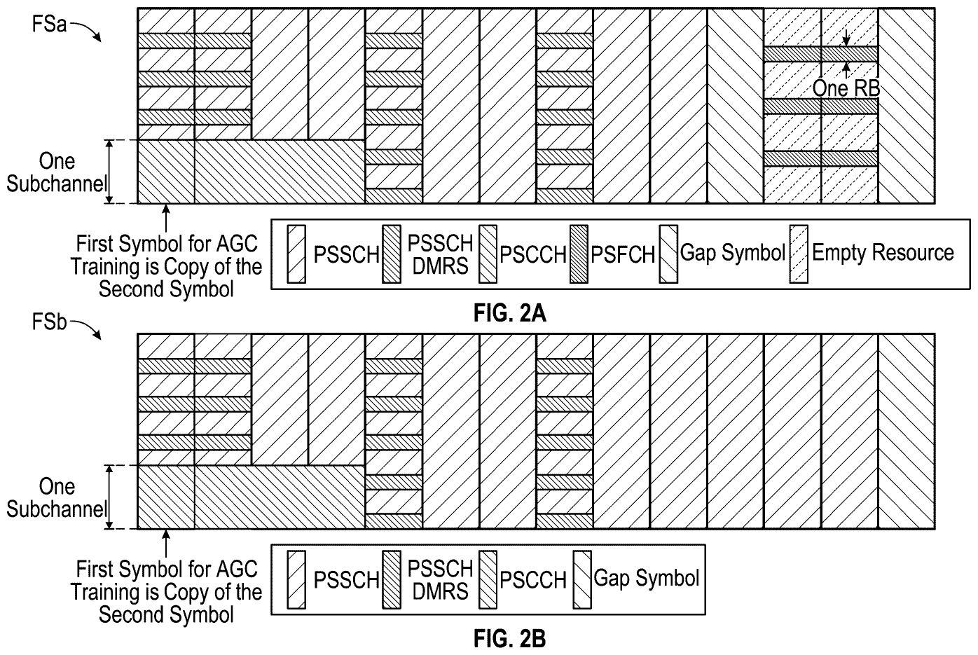

FIG. 2A is a block diagram depicting a sidelink frame structure having a slot format with feedback.

Referring to FIG. 2A, a sidelink frame structure with feedback FSa may include three main components: a physical sidelink control channel (PSCCH); a physical sidelink shared channel (PSSCH); and a physical sidelink feedback channel (PSFCH).

FIG. 2B is a block diagram depicting a sidelink frame structure having a slot format without feedback.

Referring to FIG. 2B, a sidelink frame structure without feedback FSb may include a PSCCH and a PSSCH but may not include a PSFCH.

As discussed in further detail below, in some embodiments of the present disclosure, the sidelink frame structure may be updated to minimize the impact of SL transmissions on DL reference signals and to avoid collisions between SL DMRS/SL resource elements and DL RS.

A sidelink physical channel corresponds to a set of resource elements (REs) carrying information originating from higher layers. The following sidelink physical channels are defined by communications standards (e.g., 3GPP) to include: the PSSCH, which carries second stage sidelink control information (SCI) and sidelink data payloads; physical sidelink broadcast channel (PSBCH), which is similar to (e.g., equivalent to) physical broadcast channel (PBCH) in access (Uu) link; the PSCCH, which carries first stage SCI; and the PSFCH, which carries 1-bit hybrid automatic repeat request acknowledgement (HARQ-ACK) feedback.

A sidelink physical signal corresponds to a set of resource elements used by the physical layer but does not carry information originating from the higher layers. The following sidelink physical signals are defined by communications standards: demodulation reference signals (DMRS, or DM-RS) for PSCCH, PSSCH, and PSBCH; channel-state information reference signal (CSI-RS), which is for channel state information (CSI) measurement on sidelink; phase-tracking reference signals (PT-RS), which is for frequency range 2 (FR2) phase noise compensation; sidelink primary synchronization signal (S-PSS), which is for synchronization on sidelink; and sidelink secondary synchronization signal (S-SSS), which is for synchronization on sidelink.

In NR sidelink, a self-contained approach to sidelink communications may be implemented. For example, each slot may contain control, data, and (in some cases) feedback. A NR sidelink slot (e.g., a regular NR sidelink slot) may consist of 14 orthogonal frequency-division multiplexing (OFDM) symbols. However, the sidelink may also be (pre-) configured to occupy less than 14 symbols in a slot.

SCI in NR vehicle-to-everything (V2X) may be transmitted in two stages: first stage SCI and second stage SCI. The first stage SCI (e.g., SCI format 1-A) may be carried on PSCCH and may contain information to enable sensing operations, as well as a resource allocation field for scheduling PSSCH and second stage SCI. The second stage SCI (e.g., SCI format 2-A and SCI format 2-B) may be transmitted in PSSCH resources and may be associated with the PSSCH DMRS, which contains the information for decoding the PSSCH.

The PSCCH and PSSCH may be multiplexed in time and frequency within the same slot. Depending on whether feedback is configured for a given slot, there may be different slot formats. For example, FIG. 2A shows a slot format for a case in which feedback resources are configured and FIG. 2B shows a slot format for a case in which feedback resources are not configured.

For both slot formats, the first symbol may be repeated for automatic gain control (AGC) settling, and the last symbol of the slot may be left as a gap for the time of transmission or reception (Tx/Rx) switching. The first stage SCI may be carried in PSCCH with two or three symbols. The number of PSCCH symbols may be configured (e.g., explicitly (pre-) configured) per Tx/Rx resource pool by the higher layer parameter sl-TimeResourcePSCCH. The lowest resource block (RB) (e.g., the RB having the smallest index or lowest index value) of a PSCCH may be the same as the lowest RB of the corresponding PSSCH. In the frequency domain, the number of RBs in PSCCH may be (pre-) configured to be not greater than (e.g., to be less than or equal to) the size of one sub-channel. In such cases, if a UE is using multiple consecutive subchannels for SL transmission within a slot, the PSCCH may only exist (e.g., many be provided only) in the first subchannel.

A sidelink shared channel (SL-SCH) transport channel, which carries the transport blocks (TBs) of data for transmission over SL, and the second stage SCI may be carried over the PSSCH. The resources in which the PSSCH is transmitted may be scheduled or configured by a network node (e.g., a base station/gNB) or determined through a sensing procedure conducted by the transmitter (e.g., conducted autonomously by the transmitter).

Feedback (if it exists, and as depicted in FIG. 2A) may be carried over the PSFCH. The PSFCH may be used to transmit the feedback information from Rx UEs to the Tx UEs. It can be used for unicast and groupcast options 1 and 2. In the case of unicast and groupcast option 2 the PSFCH may be used to transmit ACK/NACK whereas for the case of groupcast option 1, the PSFCH carries only NACK. For sidelink feedback, a sequence-based PSFCH format (PSFCH format 0) with one symbol (not including AGC training period) is supported. In PSFCH format 0, the acknowledgment/negative acknowledgment (ACK/NACK) bit may be transmitted through two Zadoff-Chu (ZC) sequences of length 12 (same root but different cyclic shift), whereby the presence of one sequence indicates an ACK and the presence of the other indicates a NACK. In other words, the two ZC sequences (e.g., bit sequences) may be used in a mutually exclusive manner.

As discussed above, in NR SL design, SL transmissions may be restricted in (e.g., limited to) UL slots only. When SL information is limited to being transmitted in only UL slots, the SL throughput may be degraded, and the latency may be increased due to potential bottlenecks caused by a limited availability of transmission slots for SL information. These disadvantages may be reduced (e.g., may be overcome) if SL transmissions are allowed in DL slots as well (e.g., allowed in both DL slots and UL slots). To allow for SL transmissions in DL slots as well as UL slots, an SL resource pool configuration may be updated, such that the SL resource pool configuration can incorporate DL slots. A network node (e.g., a gNB), or the sidelink UE to perform the SL transmission, may then be able to schedule SL transmission in DL slots (e.g., based on scheduling via DCI signaling). For example, there are two modes of operation for SL transmissions. In Mode 1, resources (e.g., all the resources) are scheduled by the gNB by using RRC configuration and/or DCI. In mode 2, a UE may perform sensing and detect future reservations of its neighbors and, accordingly, select resources for an upcoming transmission such that the selected resources try to avoid colliding with other UEs (e.g., the resources may be selected, by the UE, to try to avoid colliding with resources used by other UEs).

Additionally, the legacy SL frame structure may cause interference to neighboring UEs (e.g., neighbor regular UEs) receiving DL transmissions in the same DL slot as an SL transmission. The impact of this interference may be more pronounced when an SL transmission, either SL data or a SL DMRS, collides with a DL DMRS.

Aspects of some embodiments of the present disclosure provide for systems and methods to minimize such detrimental impact on the DL channel/signal of the neighboring UEs when a DL slot is used for both DL and SL transmissions.

Furthermore, in legacy specifications, there are no available procedures to handle the collision between different DL reception and SL transmission (e.g., when a sidelink UE is supposed to receive a DL transmission and to perform a sidelink transmission simultaneously in the same slot). For example, the behavior of an SL UE is not defined for when a SPS PDSCH collides with an occasion for SL transmission. Aspects of some embodiments of the present disclosure provide solutions for handling collisions between SL transmissions and DL receptions for the same SL UE in the same DL slots.

Aspects of some embodiments of the present disclosure provide for systems and methods to minimize the impact of, and/or to avoid, collisions between DL transmissions and SL transmissions associated with the same downlink slots.

### A. Applicability of Time Division Duplex (TDD) Configuration to a Subset of SL Transmissions

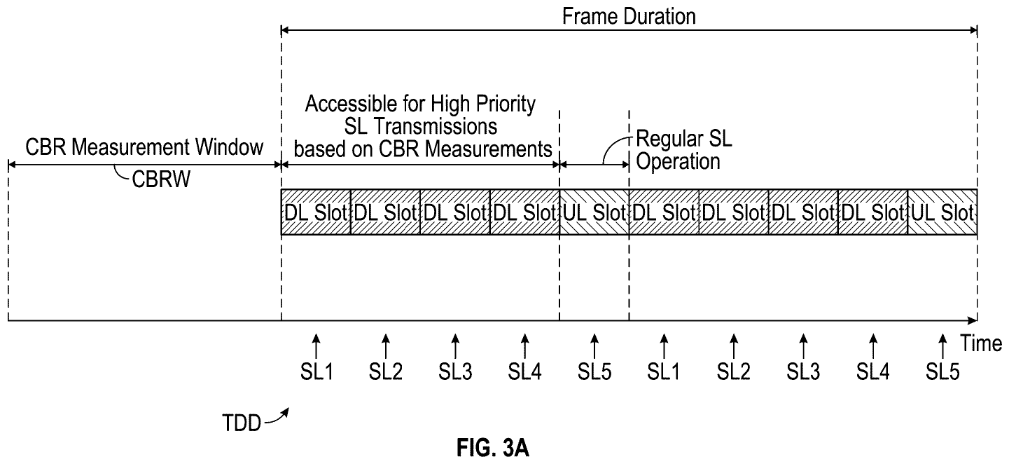

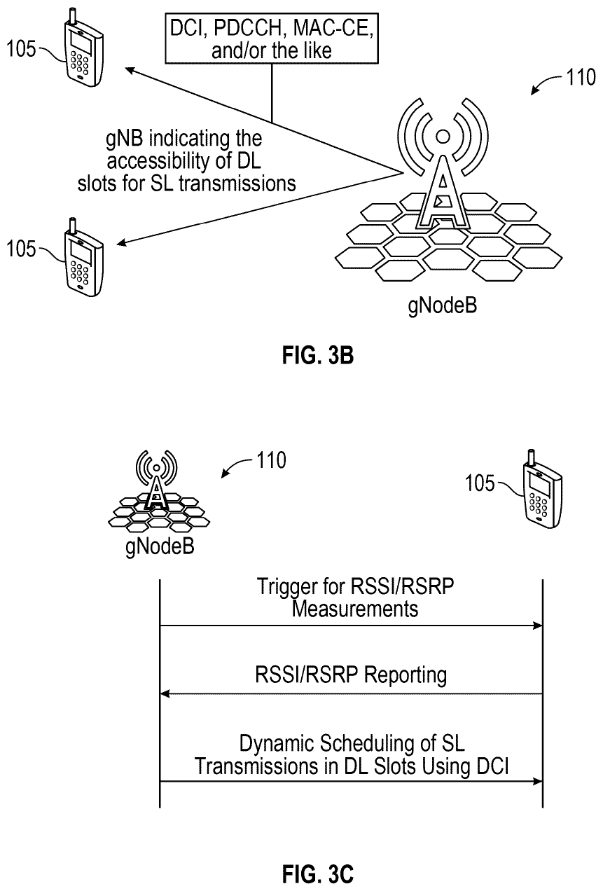

FIG. 3A is a block diagram depicting a modified use of a time division duplex (TDD) configuration that indicates UL/DL slots that are accessible to UEs for SL communications, according to some embodiments of the present disclosure.

For SL transmissions, UL slots may be identified by a time division duplex (TDD) configuration parameter indicated in the PSBCH. For example, this parameter may provide the values of X, Y, and Z, which indicate a number of patterns, the periodicity of the patterns, and the UL slots within the pattern, respectively. However, if SL transmissions are allowed in DL slots as well as UL slots, then the TDD configuration parameter might not be suitable in all cases. For example, three approaches may be considered.

First, in some embodiments, the TDD configuration parameter may be removed to improve the reliability of the PSBCH transmissions. In some embodiments, the TDD configuration parameter may be reserved for future parameters (e.g., one or more bit positions, normally allocated for use as a TDD configuration parameter, may be reserved for future use by one or more non-TDD configuration parameters).

Second, and referring to FIG. 3A, in some embodiments, the TDD configuration parameter may be maintained but may become applicable to only a subset of the SL transmissions. For example, only high priority SL transmissions (e.g., SL transmissions having a priority metric (e.g., a priority measurement) above a pre-configured priority threshold) may be allowed to transmit in DL slots (e.g., slots SL1-SL4) and thus the TDD configuration may still be applicable to SL transmissions with a priority below the (pre-) configured priority threshold. In other words, the high priority UEs may ignore the TDD configuration, while the low priority UEs may rely on the TDD configuration to identify the UL slots (e.g., slot SL5) in which they can perform their sidelink transmissions.

In some embodiments, a given UE may determine whether one or more DL slots within a subset of downlink slots (e.g., one or more downlink slots) is accessible to the UE for performing a given SL transmission (e.g., is a candidate for the given SL transmission) based on the priority metric satisfying a threshold (e.g., being greater than, less than, or equal to the threshold). In some embodiments, the priority metric may be used, by the UE, to determine which slots (e.g., of a given subset of slots, including one or more of DL slots, UL slots, and/or SL-only slots) are candidates for a given SL transmission based on performing a metric-based calculation on DL slots only.

In some embodiments, the priority threshold (e.g., the pre-configured priority threshold) may be (pre-) configured per resource pool. In some embodiments, the transmissions in DL slots may be limited to certain types of devices. For example, in some embodiments, the transmissions in DL slots may be limited to SL ultra-reliable low latency communications (URLLC) traffic. In some embodiments, the transmissions in DL slots may be limited depending on the source type. For example, vehicle UEs (vUEs), which are more likely to include safety-critical communications, may be allowed to transmit in DL slots, while pedestrian UEs, which are less likely to include safety-critical communications, may not be allowed to transmit on DL slots).

In some embodiments, the transmission in DL slots may be dynamically enabled and/or disabled based on system occupancy. For example, if the occupancy (e.g., an occupancy level) of the measured SL transmissions in UL slots is above a (pre-) configured threshold (e.g., an occupancy threshold), then SL transmissions may be allowed to transmit in DL slots or only higher priority SL transmissions may be allowed to utilize (e.g., to transmit in) the DL slots. In some embodiments, the (pre-) configured threshold may be associated with specific priorities by resource pool configuration and may be based on the measured channel busy ratio (CBR) as measured by the UEs. For example, in some embodiments, if the measured CBR is above the pre-configured threshold, then higher priority transmissions may be allowed to use the DL slots for sidelink transmissions. In some embodiments, the measured CBR (e.g., the SL CBR measurement) may be measured by one or more UEs within (e.g., during) a CBR measurement window CBRW (e.g., a (pre-) configured CBR measurement window).

In some embodiments, the (pre-) configured threshold may be dependent on the target transmission power of the UE (e.g., may be based on a target transmission power threshold). For example, SL transmissions in DL slots may be restricted (e.g., limited) to a lower transmit power to reduce the interference incurred by the neighboring UEs on the Uu link. In such cases, a (pre-) configured parameter may be applied to SL transmission power in DL slots to limit the incurred interference level. For example, the UE may receive a parameter indicating a transmission parameter limit (e.g., a transmission power limit) from the network node (or from a neighboring UE). For example, the parameter may be referred to as a transmission-power-limit parameter that indicates a transmission-power limit. That is, the transmission parameter of an SL transmission may be limited based on a parameter that is (pre-) configured or dynamically indicated to the UE. In some embodiments, the lower transmit power limit may be obtained (e.g., may be determined) by applying a (pre-) configured offset to the total transmission power limit in UL slots.

In some embodiments, the UE may perform a given SL transmission based on (e.g., using) one or more parameters (e.g., one or more transmission parameters). For example, the UE may perform the given SL transmission based on the transmission-power-limit parameter discussed above. The UE may perform the given SL transmission based on a bandwidth-related parameter indicating a bandwidth (e.g., a maximum number of resource blocks (RBs)) the UE may use for its SL transmission. The UE may perform the given SL transmission based on a parameter (e.g., an occupancy-related parameter) indicating a maximum number of transmissions the UE can schedule and/or perform within a given window (e.g., based on a channel-occupancy ratio). The UE may perform the given SL transmission based on a parameter (e.g., a feedback-related or error-checking-related parameter) indicating a HARQ configuration (e.g., indicating the presence or absence of PSFCH or a periodicity of PSFCH). The one or more transmission parameters may be (pre-) configured and/or indicated to the UE (e.g., indicated to the UE by the network node or another UE).

Third, in some embodiments, the TDD configuration (e.g., the TDD configuration parameter) may be applicable to all devices but sidelink transmissions may be limited to a subset of the DL slots. For example, in some embodiments, the network node (e.g., the gNB) may have the flexibility either to share all DL slots with SL or to share only a subset of the DL slots with SL. In some embodiments, this flexibility may be provided in a semi-static way by using (pre)-configuration (e.g., through RRC signaling). In some embodiments, the network node (e.g., the gNB) may dynamically indicate the DL slots that are accessible for SL transmissions.

FIG. 3B is a diagram depicting a network node 110 (e.g., a gNB or gNodeB) indicating accessibility of DL slots for SL transmissions, according to some embodiments of the present disclosure.

In some embodiments, DL slots (e.g., accessible DL slots) may be dynamically indicated through DCI signaling (e.g., sent in a group common (GC) physical downlink control channel (PDCCH) (GC-PDCCH)) in which the network node (e.g., the gNB) may provide a bitmap to all sidelink UEs (e.g., to all sidelink vUEs) or to a subgroup of the sidelink UEs. In some embodiments, the bitmap may include a set bit (e.g., one or more bits) to indicate an accessible DL slot. In some embodiments, the GC-PDCCH transmitted to a group of UEs (e.g., a group of vUEs) may carry (e.g., may include) a duration in which (e.g., during which) DL slots may be used for SL transmission. In some embodiments, the indication of the duration may be based on the start and length indicator value (SLIV) approach in which the network node (e.g., the gNB) may indicate to UEs (e.g., to vUEs) the start and duration of DL slots that can be used for SL transmission. The duration may be in units of symbols, slots, subframes, and/or the like. In some embodiments, the duration may be counted over the DL slots (e.g., may be counted over the logical DL slots) to avoid impacting UL slots within the indicated duration.

Because GC-PDCCH may be transmitted to multiple groups of UEs (e.g., to multiple groups of vUEs), it may be suitable for each group of UEs to know (e.g., to have information indicating) the location of the corresponding field in a GC-PDCCH indicating information regarding DL slots that can be used for SL transmission. In some embodiments, the gNB may provide each group of the UEs (e.g., the vUEs) with the field location in GC-PDCCH via higher layer signaling (e.g., positionInDCI). In some embodiments, each UE within a particular group may derive the field location in the GC-PDCCH. In some embodiments, one or more rules based on UE identification (ID) or group ID may be used to indicate the location of the corresponding field in a GC-PDCCH. For example, in some embodiments, a rule may be established that the field number in the GC-PDCCH is equal to the group number. For example, in some embodiments, the UEs (e.g., the vUEs) in a first group may apply the information provided in the first field (e.g., the field corresponding to the most significant bit), the UEs (e.g., the vUEs) in a second group may apply the information provided in the second field after (e.g., following) the first field, and so on.

In some embodiments, the network node (e.g., the gNB) may indicate the number of groups addressed by GC-PDCCH. In such embodiments, the UE (e.g., the vUE) may determine the location (or an index) of the corresponding field in DCI (e.g., by group numbers of the groups addressed by GC-PDCCH). In such embodiments, all the fields (e.g., all fields in the DCI) may have the same size. For example, the size of a field may be predefined in a specification (e.g., the 3GPP specification). In some embodiments, the network node (e.g., the gNB) may indicate the size of the field to the UEs (e.g., to the vUEs) via higher layer signaling. In some embodiments, the UEs (e.g., the vUEs) may derive (e.g., determine or calculate) the size of the field. For example, if a SLIV approach is used, the field size may depend on the associated configured Telecommunications and Digital Government Regulatory Authority (TDRA) table. For example, if the associated TDRA table has 16 rows of SLIVs, then the field may have 4 bits. In some embodiments, in addition to (or as an alternative to) GC-PDCCH, a UE-specific PDCCH may be used to indicate DL slots that may be used for SL transmission.

In some embodiments, the dynamic indication of the accessible DL slots may be sent to the neighboring UEs (e.g., the neighboring vUEs) through medium access control (MAC) control element (MAC-CE) and can be associated with a validity (e.g., either a (pre-) configured validity or an indicated validity) in the MAC-CE. In some embodiments, the UEs (e.g., the vUEs) may use the DL slots indicated by the MAC-CE for SL transmissions, as long as a validity timer is active. In such embodiments, the network node (e.g., the gNB) may then elect to transmit only low priority DL transmissions on the DL slots that are shared with sidelink to reduce the impact of the interference incurred by the DL Uu link.

In some embodiments, sidelink transmissions in DL slots may be scheduled by the network node (e.g., by the gNB). In such embodiments, the gNB may use a dynamic grant (e.g., a dynamic grant in DCI signaling) or a configured grant (e.g., RRC+DCI or RRC) to schedule sidelink transmissions in DL slots indicated by the TDD configuration.

FIG. 3C is a diagram depicting a method for determining SL scheduling based on signal strength measurements, according to some embodiments of the present disclosure.

Referring to FIG. 3C, in some embodiments, the scheduling of these sidelink transmissions may be dependent on a received measurement by the scheduled UE (e.g., the scheduled vUE) or its neighboring devices. That is, in some embodiments, sidelink scheduling may be determined based on measurements performed by the scheduled UE or one or more of the scheduled UEs neighboring devices.

In some embodiments, the measurements may include received signal strength indicator (RSSI) measurements and/or reference signal received power (RSRP) measurements performed to identify the potential impact of interference. For example, the UE may determine an interference-related parameter (e.g., a channel-congestion metric) based on the RSSI measurements and/or based on the RSRP measurements. The UE may use the interference-related parameter (e.g., the channel-congestion metric) to determine whether to perform a sidelink transmission in a downlink slot. For example, the UE may determine whether one or more DL slots within a subset of downlink slots (e.g., one or more downlink slots) is accessible to the UE for performing a given SL transmission (e.g., is a candidate for the given SL transmission) based on the interference-related metric (e.g., based on the channel-congestion metric) satisfying a threshold (e.g., being greater than, less than, or equal to the threshold). The interference-related parameter may allow the UE to determine whether interference resulting from performing the sidelink transmission in the downlink slot may cause an unacceptable level of interference. In some embodiments, the interference-related parameter (e.g., the channel-congestion metric) may be used, by the UE, to determine which slots (e.g., of a given subset of slots, including one or more of DL slots, UL slots, and/or SL-only slots) are candidates for a given SL transmission based on performing a metric-based calculation on DL slots only.

In some embodiments, these measurements may be performed on a (pre-) configured duration and may be triggered either externally by the network node (e.g., the gNB) before scheduling a SL transmission or internally by the device (e.g., by the UE) before requesting a resource scheduling from the network node (e.g., the gNB). Because these measurements may result in delays, such measurements may be more suitable for devices (e.g., for UEs) with limited mobility. In summary, in some embodiments, a UE may perform a signal strength measurement and the same UE or another UE may perform a sidelink transmission that is scheduled on resources that are selected based on the signal strength measurement.

In some embodiments, the network node (e.g., the gNB) may associate one or more priority thresholds with the DL slots that are accessible for SL transmissions (e.g., may associate priority thresholds with the accessible DL slots). In some embodiments, the priority (e.g., the one or more priority thresholds) may be indicated dynamically or semi-statically, as discussed above, and may be used as follows. In some embodiments, only sidelink transmissions with priority above the indicated priority threshold may use the DL slots for sidelink transmissions. In some embodiments, the indicated priority may be used to obtain an RSSI and/or RSRP threshold. In some embodiments, the UE (e.g., the vUE) may be allowed to perform a sidelink transmission in a DL slot only if the measured RSSI and/or RSRP is below the indicated threshold. In some embodiments, these thresholds may be (pre-) configured. In some embodiments, these thresholds may be standardized.

In summary, in some embodiments, the TDD configuration parameter within the PSBCH may be applied only to a subset of the UEs (e.g., only to low priority UEs). In some embodiments, performing SL transmissions within DL slots may be limited to UEs with priority above a (pre-) configured threshold or to a certain UE type (e.g., to vehicular UEs). In some embodiments, performing sidelink transmissions in DL slots may be dynamically enabled and/or disabled based on system occupancy (e.g., if the measured CBR in UL slots is above a (pre-) configured threshold). In some embodiments, the pre-configured CBR thresholds for accessing DL slots may be based on SL transmissions priority. In some embodiments, SL transmissions in DL slots may be (pre-) configured with lower total transmission power limits when compared to UL slots (e.g., by applying a (pre-) configured offset to the total transmission power limit in UL slots). In some embodiments, SL transmissions in DL slots may be restricted to a subset of the DL slots either semi-statically by (pre)-configuration or dynamically through DCI signaling. In some embodiments, a network node (e.g., a gNB) may schedule SL transmissions in DL slots by either using a dynamic grant or by using a configured grant. This scheduling may be based on measurements performed by the scheduled device (e.g., the scheduled UE) or its neighboring devices (e.g., its neighboring UEs) over a (pre-) configured duration. In some embodiments, the measurements performed by the device (e.g., by the UE), before sending a SL transmission in a DL slot, may be triggered internally by the device (e.g., by the UE) or externally by the network node (e.g., the gNB). In some embodiments, the network node (e.g., the gNB) may associate one or more priority thresholds with the DL slots that indicate the RSSI and/or RSRP threshold for accessing the DL slot.

### B. Sidelink Slot Structure Update for SL Transmissions with Simultaneous Downlink Transmissions

When a UE performs a SL transmission in a DL slot, other neighboring UEs may be simultaneously receiving DL transmissions from the network node (e.g., from the gNB). In such cases, sidelink transmission may interfere with the DL transmissions coming from the network node (e.g., from the gNB). Although this interference issue may be resolved by the network node (e.g., the gNB) in the case of Mode 1 operation, in which all sidelink transmissions are scheduled by the network node (e.g., the gNB), there are some scenarios in which interference may still occur. For example, the following cases may occur and result in interference. SL transmissions occurring at the cell boundary and their resources may be selected based on UE sensing (e.g., the Mode 2 resource selection procedure). When the system is highly occupied thus forcing the network node (e.g., the gNB) to schedule overlapping sidelink and DL transmissions to maintain a minimum throughput to all UEs. When there exists a SL/DL transmission with a limited latency budget. For example, when a DL transmission is scheduled, and then a SL transmission with low latency requirement is scheduled in the same slot.

In such cases, the interference may be handled between the SL reference signals (RS) (e.g., DMRS and DL RS). For example, in some embodiments, collisions between SL and DL RSs may be avoided to ensure better quality channel estimation and to improve the reliability of the concurrent SL/DL transmissions. For example, and as discussed in further detail below, the UE may perform a channel-estimation procedure based on adjusting (e.g., modifying) a SL DMRS pattern or based on adjusting (e.g., modifying) a SL DMRS density to avoid collisions with DL reference signals. That is, the UE may perform the channel-estimation procedure based on a modified SL DMRS pattern or based on a modified SL DMRS density to reduce the chance (e.g., a risk, a probability, or a likelihood) of a collision occurring between SL and DL RSs and/or to improve the reliability of the concurrent SL/DL transmissions. To achieve this, the following approaches may be utilized.

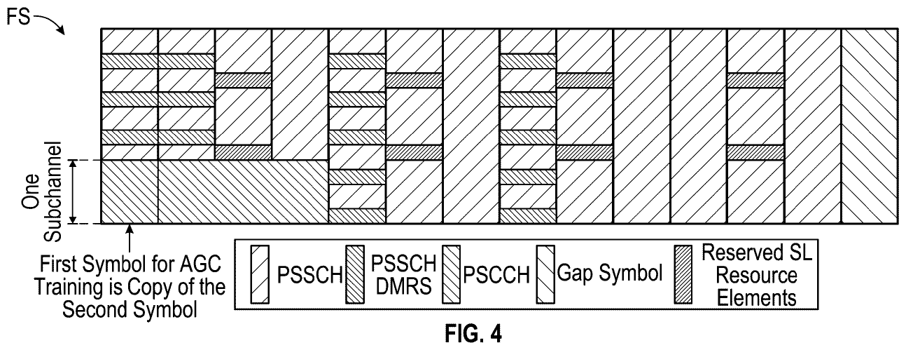

FIG. 4 is a block diagram depicting reserved SL resource elements within a SL frame structure FS to avoid collisions with DL RS, according to some embodiments of the present disclosure.

Referring to FIG. 4, in some embodiments, the impact from SL on DL RS may be minimized by using a modified SL frame structure that reserves a subset of the SL data/control resource elements that would collide with the DL RS. In some embodiments, the locations of the reserved SL resource elements may be dependent on resource pool (pre-) configuration. In some embodiments, a UE may follow the standard SL slot structure and may puncture, rate match, or reduce its transmit power in the resource elements at the locations overlapping with the DL RS. In such embodiments, a SL UE transmitting in a DL slot may apply an offset to lower its modulation and coding scheme (MCS) across the whole slot when transmitting in DL symbols to mitigate the impact of puncturing the reserved SL resource elements on the reliability of the SL transmissions. In some embodiments, the offset may be (pre-) configured per resource pool, such that it is not indicated to the Rx UE (e.g., the receiving vUE).

In some embodiments, the locations of these reserved SL resource elements may be provided in the form of bitmaps. For example, one bitmap may be used for indicating the time domain resources and each bit may correspond to a particular time domain resource (e.g., a symbol, a slot, a subframe, and/or the like). In some embodiments, another bitmap may indicate the frequency domain, and each bit may correspond to a frequency resource (e.g., a subcarrier, an RB, a subchannel, and/or the like).

In some embodiments, to avoid degrading the quality of the SL channel estimation

and to avoid increasing the complexity of the SL channel estimation, the UE (e.g., the vUE) may not expect any resources carrying SL DMRS to be indicated as reserved SL REs. To achieve this, in some embodiments, predefined (e.g., pre-configured) puncturing patterns may be included in the specification (e.g., the 3GPP specification), each of the puncturing patterns indicating a specific subset of the resource elements to be punctured by (e.g., to be excluded from use for) sidelink transmissions. In some embodiments, the puncturing patterns may be (pre-) configured (e.g., through RRC signaling) per resource pool. In such embodiments, instead of cancelling the SL transmissions, the network node (e.g., the gNB) may send a pattern index to the SL UE to perform the puncturing using the same (or similar) indication methods discussed above. For example, the network node (e.g., the gNB) may indicate the puncturing pattern to the UE (e.g., the vUE) by a bitmap. For example, the UE that is to perform an SL transmission, or another UE (e.g., a receiving UE), may perform an SL channel estimation for the SL transmission. The SL channel estimation may be performed based on a puncturing pattern indicating a subset of resource elements to be excluded from use for sidelink transmissions.

In some embodiments, to minimize (e.g., to reduce) the impact from SL DMRS on DL RS, new SL DMRS symbol combinations may be defined (e.g., by (pre)-configuration) such that the SL DMRS do not overlap with the DL RS. In other words, a UE (e.g., a vUE) may not be expected to transmit SL DMRS in symbols that overlap with the DL RS when transmitting in a DL slot. To this end, the network node (e.g., the gNB) may indicate to the UE (e.g., the vUE) one or more symbols in which SL DMRS may not be transmitted (e.g., symbols that are punctured from use for transmitting SL DMRS). In some embodiments, the UE may not transmit DMRS in the REs that are supposed to carry DMRS and, instead, may leave the REs empty. In some embodiments, the UE may utilize such REs to transmit SL data or control channel. In some embodiments, the network node (e.g., the gNB) may indicate to the UE (e.g., the vUE) which symbols within the slot may or may not carry SL DMRS. For example, a bitmap may be used for this purpose and each bit may correspond to a particular time domain granularity, a symbol, a group of symbols, and/or the like.

To minimize (e.g., to reduce) the impact on channel estimation, in some embodiments, the time gap between the SL DMRS may remain fixed. Therefore, the network node (e.g., the gNB) may indicate to the UE (e.g., to the vUE) to shift the location of the SL DMRS symbols.

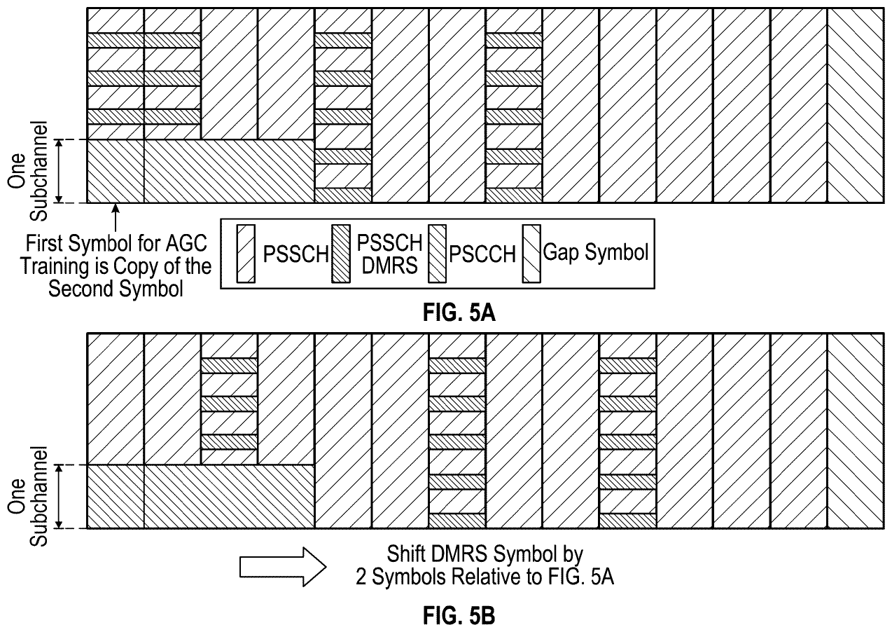

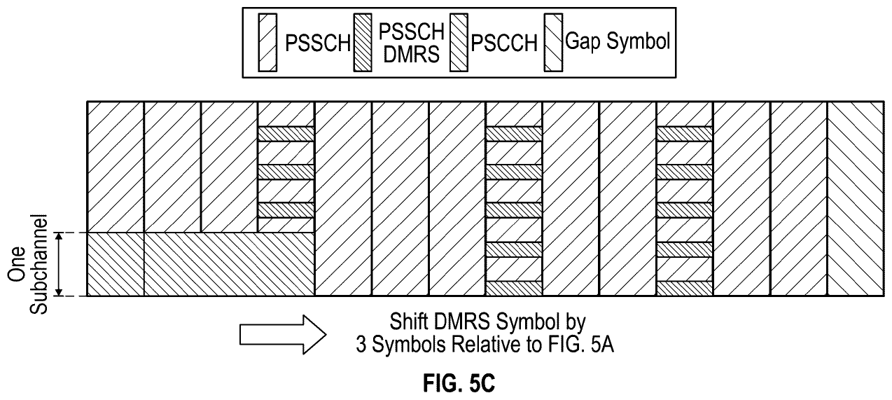

FIGS. 5A, 5B, and 5C (collectively, FIG. 5) are block diagrams depicting a shifting of the SL DMRS, according to some embodiments of the present disclosure.

FIG. 5A depicts the possible original SL DMRS location within a slot. FIG. 5B depicts a shifting of the SL DMRS by two symbols relative to the original location. FIG. 5C depicts a shifting of the SL DMRS by three symbols relative to the original location. In some embodiments, the shift amount may be configured by higher layer signaling and may be configured per resource pool. In some embodiments, the shift amount may be dynamically indicated by PDCCH or MAC-CE.

In some embodiments, a less dense DMRS pattern may be used for SL transmissions to avoid overlapping with DL RS. For example, SL DMRS may follow a comb-4 or comb-8 structure). Comb-4 and comb-8 refer to a density of the DMRS. For example, a comb-4 means that every fourth resource clement is a DMRS, whereas comb-8 means that every eighth resource clement is a DMRS. In such embodiments, a SL UE transmitting in a DL slot may apply an offset to lower its MCS when transmitting in DL symbols to mitigate the impact of puncturing the reserved SL resource elements on the reliability of the SL transmissions. In some embodiments, the offset may be (pre-) configured per resource pool. In some embodiments, the selection of the low-density SL DMRS patterns may be based on a trigger from the network node (e.g., the gNB). For example, in some embodiments, multiple DMRS densities may be (pre-) configured per resource pool and the network node (e.g., the gNB) may provide an index of the density to be employed by the SL UEs (e.g., the SL vUEs) in upcoming transmissions. In some embodiments, a default density may be (pre-) configured such that the UEs (e.g., the vUEs) are expected to use the DMRS density indicated by the network node (e.g., the gNB) for a given duration and then revert back to the default DMRS density. In some embodiments, this duration may be either (pre-) configured per resource pool or it may be indicated by the gNB as discussed below. For example, the UE that is to perform an SL transmission, or another UE, may perform an SL channel estimation for the SL transmission. The SL channel estimation may be performed based on an altered DMRS pattern or an altered DMRS density that is transmitted by the UE performing the SL transmission.

In some embodiments, the modifications to the SL DMRS (e.g., dropping the symbols carrying SL DMRS, shifting the symbols carrying SL DMRS using less dense DMRS, or any other enhancement) may not be applied to all DL slots carrying the SL transmission. For example, in some DL slots, the network node (e.g., the gNB) may protect the DL transmission and modify the concurrent SL transmission accordingly. However, in other DL slots, such protection may not be suitable. In such situations, the network node (e.g., the gNB) may indicate in which DL slot the SL transmission may be modified and in which DL slot the SL transmission may remain the same as an SL transmission in a legacy UL slot (e.g., in an unmodified/normal UL slot).

To this end, the network node (e.g., the gNB) may indicate to the UE (e.g., the vUE) the nature of the SL (e.g., normal or modified). For example, this indication may be carried via higher layer signaling such as RRC. In some embodiments, the indication may be provided in the form of a bitmap of a particular length and the configured pattern may be repeated periodically. In some embodiments, each bit may correspond to a specific time-domain granularity, symbols, slots, subframes, and/or the like. In some embodiments, to reduce the payload, the bitmap may correspond to only the DL slots that are supposed to carry SL transmission.

In some embodiments, the indication of the nature of the SL may be carried via dynamic channels such as UE-specific PDCCH, GC-PDCCH, or MAC-CE.

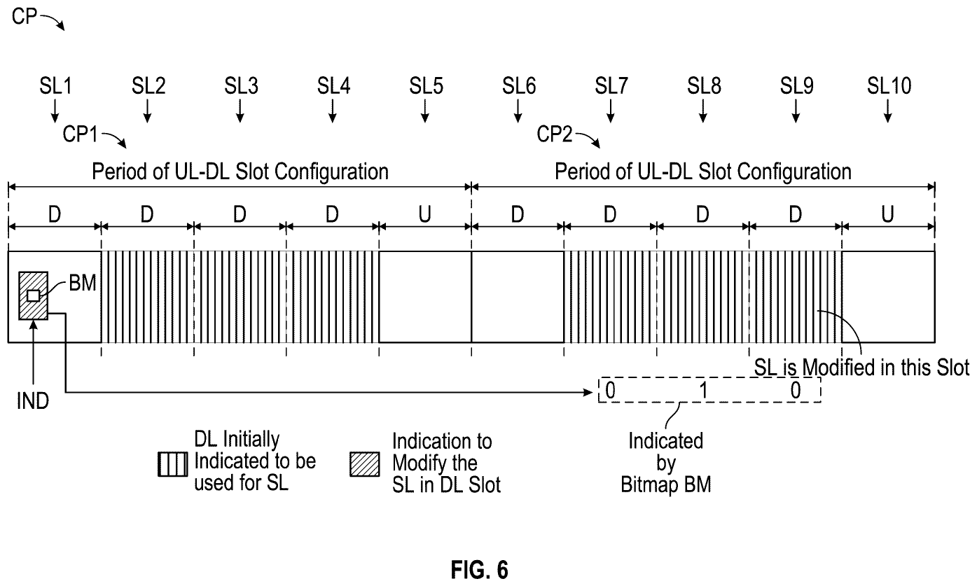

FIG. 6 is a block diagram depicting a method for modifying a sidelink transmission in a DL slot, according to some embodiments of the present disclosure.

Referring to FIG. 6, an example of multiple UL-DL slot configuration periods CP (e.g., CP1 and CP2) (also referred to as “configurations periods”) is shown. Each configuration period CP includes five slots (e.g., SL1-SL5 associated with CP1, and SL6-SL10 associated with CP2), where the first four slots (e.g., SL1-SL4 and SL6-SL9) are indicated as downlink slots, and last slots (e.g., SL5 and SL10) are indicated as uplink slots. As such, the five slots in each configuration period CP may be represented by the notation “DDDDU.” Initially, the SL is allowed in the second, third, and fourth downlink slots (e.g., SL2, SL3, and SL4 of CP1, and SL7, SL8, and SL9 of CP2). In the first UL-DL slot configuration period CP1, the network node (e.g., the gNB) transmits an indication IND (e.g., via a GC-PDCCH) to indicate in which slot the SL transmission may be modified.

The indication IND may carry a bitmap BM in which each bit may correspond to a particular time unit, such as a DL slot/symbol, the entire UL-DL configuration period CP, a subframe, and/or the like. To reduce its payload or DMRS density, the bitmap BM may be applied only to the slot and/or symbols indicated to have SL transmissions. To further reduce the payload, each bit may correspond to all SL transmissions in a time period. For example, a single bit may correspond to the whole UL-DL slot configuration period CP (e.g., may correspond to the whole of CP1 or CP2). In this case, all SL transmissions within this period (e.g., within CP2) may be modified. In some embodiments, after the end of the duration indicated by the bitmap BM, SL transmissions may resume to occur, without modification, in the DL slots and/or symbols based on the earlier configurations (e.g., based on previous configurations, which were provided before modification).

In some embodiments, the bitmap BM may be applied after a time gap relative to the reception of the indication IND. For example, the indication IND may be applied to the next UL-DL slot configuration period CP2. This may be beneficial to provide the UE with some time to receive and decode the indication IND. In some embodiments, the applicability of this time gap (e.g., the length of the time gap) may be similar to the time period that is suitable for receiving PDSCH. In some embodiments, the applicability of this time gap (e.g., the length of the time gap) may be similar to the time period that is suitable for applying the indicated beam in the unified TCI state framework.

In some embodiments, instead of using a bitmap, the indication IND may be provided via RRC, MAC-CE, or PDCCH and may indicate (e.g., may directly indicate) the time duration at which SL transmission within DL slots/symbols is modified. For example, the indication IND may provide information on the start and length of the period in which SL transmission within DL slots/symbols is modified. In some embodiments, the information may be provided in the form of SLIV. For example, the network node (e.g., the gNB) may configure multiple SLIVs by higher layer signaling, similar to the TDRA table, and then the indication IND may (via RRC, MAC-CE, or PDCCH) indicate which row of the SLIV is to be applied in determining the time duration at which SL transmission within DL slots/symbols is modified.

In some embodiments, the network node (e.g., the gNB) may indicate to the UE (e.g., the vUE) in which frequency domain resources normal SL DMRS or modified SL DMRS may be applied. In some embodiments, the solutions discussed above for indicating the location of the canceled SL in both time domain and frequency domain may be extended for indicating the location of modified SL DMRS in both the time domain and the frequency domain.

In some embodiments, the time domain and the frequency domain resources in which SL DMRS is modified may be indicated using periodic or semi-persistent indication. In such embodiments, the periodicity may be in units of symbols, slots, subframes, or UL-DL slot configuration periods CP. In some embodiments, the periodicity may be provided via higher layer signaling (e.g., via RRC). In some embodiments, the indication IND may be carried via RRC or MAC-CE. For SL modification based on RRC signaling, the indication IND may carry information on (e.g., regarding) the time domain resources, frequency domain resources, and their periodicity. The solutions discussed above, or any other solutions suitable for indicating the time domain resources and the frequency domain resources may be applied.

For SL modification based on MAC-CE signaling, higher layer signaling, such as RRC, may configure multiple groups of the resources to be modified. Each group of resources to be modified may include (e.g., may be defined by) its time domain resources, frequency domain resources, and their periodicity. In some embodiments, to facilitate the MAC-CE indication, each group may be associated with an index, and MAC-CE may indicate the group index to be activated (e.g., to be applied). Table 1 below shows an example of such RRC configurations and associating each group of resources to an index to be indicated via MAC-CE. In some embodiments, additional information may be included in each group, such as the applicable subcarrier spacing (SCS). Although Table 1 shows that the time domain resources and frequency domain resources are indicated via bitmap, other solutions described herein or other possibilities suitable for indicating the time domain resources and frequency resources may be used.

TABLE 1
Configuring the resources of SL transmission to
be canceled based on MAC-CE indication

| | Resources information for modifying |
|---|---|
| Index | SL transmission in DL slots |
| 0 | Periodicity: every UL-DL slot configuration period |
| | Time domain resources: 010 referring to |
| | modifying SL in the second DL slot |
| | Frequency domain resources: 1000 referring |
| | to modifying SL in the subchannel #0 |
| 1 | Periodicity: every other UL-DL slot configuration period |
| | Time domain resources: 100 referring |
| | to modifying SL in the first DL slot |
| | Frequency domain resources: 1100 referring |
| | to modifying SL in the subchannel #0 and #1 |
| 2 | Periodicity: every x slots |
| | Time domain resources: 100 referring |
| | to modifying SL in the first DL slot |
| | Frequency domain resources: 1100 referring |
| | to modifying SL in the subchannel #0 and #1 |
| | . . . |

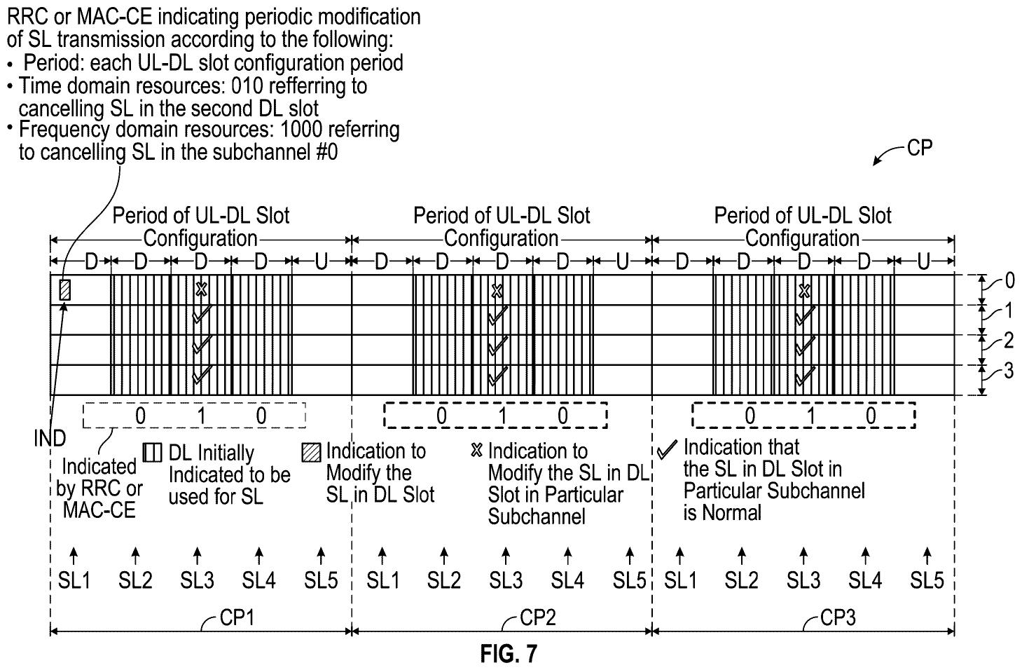

FIG. 7 is a diagram depicting a periodic or a semi-persistent modification of SL in DL slots in a particular SL subchannel, according to some embodiments of the present disclosure.

Referring to FIG. 7, an indication IND carried via RRC or MAC-CE is shown. The periodicity depicted in FIG. 7 is every UL-DL slot configuration, meaning that the indicated pattern of the SL transmission to be modified may be repeated until RRC release or MAC-CE deactivation. The pattern in each period (e.g., in each configuration period CP1, CP2, and CP3) may be provided via the time domain resources and the frequency domain resources. For example, the pattern for the time domain resources is 010, which may indicate that the SL in the second DL slot in each period is to be modified, while the pattern for the frequency domain resources is 1000 indicating that the SL in the subchannel #0 in each period is to be modified.

In some embodiments, the UE (e.g., the vUE) may be provided with some time to receive the indication IND and to act accordingly (e.g., and to perform sidelink transmission according to the received indication IND). Therefore, for the case in which the indication identifies when the SL DMRS is to be canceled or modified, the UE (e.g., the vUE) can use the solutions discussed above for defining a minimum processing timeline between the reception of the indication IND of modifying SL transmission in DL slot and the earlier time (e.g., the earliest time) in which the indication IND may be applied.

In summary, in some embodiments, when transmitting SL in a DL slot, a UE may puncture or rate match the SL resource elements overlapping with DL RSs (e.g., a lower MCS may be used based on a (pre-) configured offset to maintain reliability). In some embodiments, a bitmap may be used by the network node (e.g., the gNB) to indicate the sidelink time and/or frequency resource elements to be punctured to avoid colliding with the DL RS. In some embodiments, the puncturing patterns for sidelink transmissions may be pre-configured by RRC signaling or defined in a specification (e.g., the 3GPP specification) to reduce the signaling overhead. In some embodiments, SL DMRS may not be expected to coexist in the same symbols in which DL RS are transmitted. In some embodiments, new SL DMRS symbol combinations or less dense DMRS patterns (e.g., comb 4) may be used for SL transmissions in DL slots. In some embodiments, the network node (e.g., the gNB) may use a bitmap or RRC signaling to indicate the SL slots with modified DMRS pattern and/or payload subject to processing time requirements (e.g., the time to process the received bitmap at the SL vUE).

### C. Prioritization Between SL and DL Transmissions Based on Previous Transmissions

In some embodiments, a UE may perform a prioritization between SL and DL transmissions. For example, the UE may perform a SL transmission and may receive a DL transmission in the same slot. The UE may determine whether the SL transmission or the DL transmission has priority based on one or more prioritization methods. In some embodiments, the prioritization may be based on (e.g., may be determined based on) (pre-) configured priority thresholds. For example, when the priority of the SL transmission is above a pre-configured threshold and the DL priority is low, the UE may determine that the SL transmission has priority over (e.g., has a higher priority than) the DL transmission and may perform the SL transmission, instead of receiving the DL transmission, in the slot. This method of prioritization may be advantageous for its simplicity. However, this method of prioritization may hinder system performance for cases in which the reliability of the SL transmission and the DL transmission are significantly different. For example, prioritizing a SL transmission with a significantly low reliability may result in a resource wastage because the SL transmission may have to be retransmitted since the SL transmission has a low reliability and is likely to fail. In this case, a resource may be wasted because it could have been otherwise used by the DL transmission instead of a failed SL transmission. To address this issue, a more dynamic method may be implemented in which the reliability of one or more previous transmissions and/or the channel quality may be taken into consideration in determining prioritization. In some embodiments, this history-based approach may be used only if the DL transmission has a relatively high priority.

In some embodiments, the following methods may be used when performing SL/DL prioritization (e.g., when determining prioritization between a SL transmission and a DL transmission associated with the same slot).

In some embodiments, a UE may perform a feedback-based prioritization method. For example, before performing a prioritization at a slot n, the UE may establish a measurement window and collect the ratio of successful SL transmissions and successful DL transmissions. In some embodiments, the UE may divide the number of SL ACKed (e.g., SL acknowledged) transmissions over the total number of SL transmissions within the measurement window and may compare the result (e.g., the resulting ratio) to a ratio of the ACKed DL transmissions to the total number of DL transmissions within the measurement window. In such embodiments, the UE may favor the transmission (e.g., may prioritize the transmission type) with the higher ratio. For example, the UE may prioritize transmissions of the transmission type (e.g., SL or DL) with the higher ratio.

In some embodiments, the UE may perform the feedback-based prioritization method only if the priority of the SL transmissions and the DL transmissions are respectively below, or respectively above, a (pre-) configured SL threshold and a (pre-) configured DL threshold. For example, if a first transmission type has a higher (e.g., a much higher priority) than a second transmission type, then the first transmission type may be prioritized irrespective of the ratio of the previously ACKed transmissions. For example, if the priority of the DL transmission is high, then the previously ACKed transmissions ratio may be considered only if the priority of the SL transmission is below a threshold (e.g., a threshold value of 3).

In some embodiments, the UE may rely on the previous acknowledgement/negative acknowledgement (ACK/NACK) feedback instances within a window (e.g., within a measurement window). In such embodiments, and in some scenarios, the SL feedback may be disabled to cause a number of ACK/NACK feedback instances generated and/or received within the measurement window to be below a (pre-) configured threshold (e.g., zero to one instances of ACK/NACK feedback received within the measurement window). Based on SL feedback being disabled or the number of received ACK/NACK feedbacks within the measurement window being below a threshold, the UE may skip (e.g., may stop) relying on the ACK/NACK history when performing the prioritization. In such embodiments, the prioritization between the SL transmissions and the DL transmissions may be determined, by the UE, based on (e.g., may be solely dependent on) their (pre-) configured priority thresholds. In some embodiments, the duration of the measurement window for the slot n may be between n-T₀ and n-T_{proc}, wherein T₀ refers to a (pre-) configured parameter that indicates the beginning of the measurement window, and T_{proc} refers to the time suitable for: processing the received ACK/NACK feedback; performing the SL/DL prioritization; and becoming ready to perform either the SL transmission or the DL transmission.

In some embodiments, the UE may perform a quality-based prioritization method (e.g., a channel quality indicator (CQI)-based prioritization method). For example, before performing a prioritization at the slot n, the UE may establish a measurement window during which it collects quality measurements (e.g., CQI measurements) for SL and DL. In some embodiments, the UE may use the collected CQI measurements to identify the DL and SL link qualities and decide (e.g., determine) whether to prioritize the DL transmissions or the SL transmissions based on the link qualities. In some embodiments, if both the SL transmissions and the DL transmissions have high priorities, the UE may favor (e.g., may prioritize) the transmission with a higher average CQI measurement in the measurement window. In some embodiments, the UE may determine the prioritization based on the last measured CQI value.

In some embodiments, the UE may perform the quality-based prioritization method (e.g., the CQI-based prioritization method) only if the priority of the SL and DL transmissions are respectively below, or respectively above, a (pre-) configured SL threshold and a (pre-) configured DL threshold. For example, if a first transmission has a much higher priority than a second transmission, then the UE may prioritize the first transmission irrespective of the CQI measurements. For example, if the priority of the DL transmission is high, then the CQI measurements may be considered only if the priority of the SL transmission is below a threshold (e.g., a threshold value of 2).

In some embodiments, when a CQI measurement window is considered, the duration of the measurement window for the slot n may be between n-T₁ and n-T_{proc,1}, wherein T₁ refers to a (pre-) configured parameter indicating the beginning of the window, and T_{proc,1} refers to the time suitable for: processing the received CQI measurements; performing the SL/DL prioritization; and becoming ready to perform either the SL or DL transmission.

In some embodiments, the UE may perform an MCS-based prioritization method. For example, and similar to the CQI-based prioritization method, a UE may favor either the DL transmissions or the SL transmissions based on an average MCS level for previous transmissions within a (pre-) configured window or based on the current MCS. In some embodiments, the UE may identify the DL and SL link qualities and decide (e.g., determine) whether to prioritize the DL transmissions or SL transmissions.

In some embodiments, if both the SL and DL have high priorities, the UE may favor the transmission with a higher average MCS within the measurement window. In some embodiments, the UE may perform the MCS-based prioritization method only if the priority of the SL transmissions and the DL transmissions are respectively below, or respectively above, a (pre-) configured SL threshold and a (pre-) configured DL threshold. For example, if a first transmission (e.g., a first transmission type) has a higher priority (e.g., a much higher priority) than a second transmission (e.g., a second transmission type), then the first transmission may be prioritized irrespective of the average MCS within the measurement window. In some embodiments, the duration of the measurement window for the slot n may be between n-T₂ and n-T_{proc,2}, wherein T₂ refers to a (pre-) configured parameter that identifies the beginning of the window, and T_{proc,2} refers to the time suitable for: obtaining the average MCS; performing the SL/DL prioritization; and becoming ready to perform either the SL or DL transmission.

In summary, in some embodiments, prioritization between SL transmissions and DL transmissions may be based on one or more of: a ratio of the received ACKs to the total number of transmissions within a given measurement window; a measured CQI within a given measurement window; or the average MCS used in previous transmissions within a given measurement window. In some embodiments, the boundaries of the measurement window may be (pre-) configured per resource pool. In some embodiments, the modified prioritization rules may be applicable only when the SL and DL transmissions have priorities above or below (pre-) configured thresholds (e.g., when the SL and DL transmissions have priorities satisfying a threshold value).

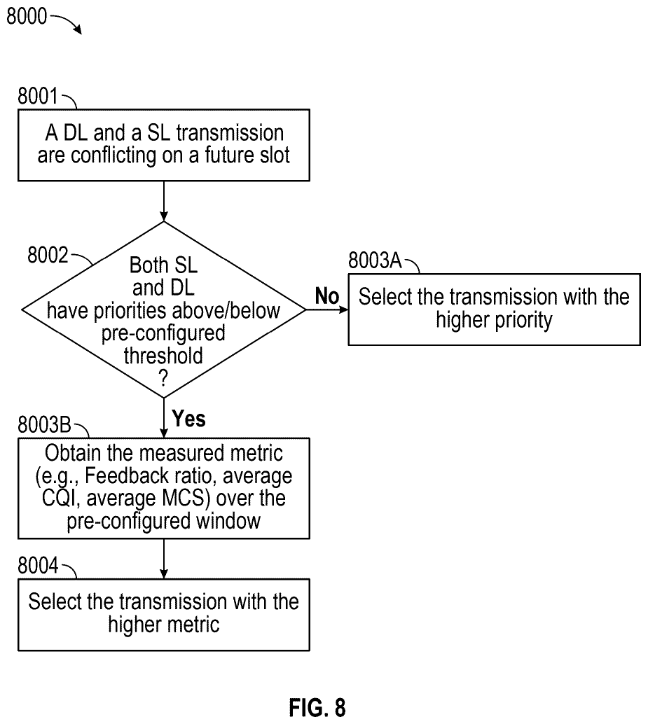

FIG. 8 is a flowchart depicting example operations of a method 8000 for determining a prioritization between sidelink and downlink transmissions, according to some embodiments of the present disclosure.

Referring to FIG. 8, the method 8000 may include one or more of the following operations. A UE 105 may determine that a DL transmission and a SL transmission are conflicting on a future slot (operation 8001). For example, the UE 105 may receive information from a network node 110 or from another device indicating that the UE 105 is to receive a DL transmission and to perform a SL transmission in the same slot (e.g., the UE is to handle the DL transmission and the SL transmission simultaneously). The UE 105 may determine whether both the SL and the DL have priorities above or below a threshold (e.g., a pre-configured threshold) (operation 8002). For example, the UE 105 may determine whether both the SL and the DL satisfy respective SL and DL thresholds. Based on determining that one or more of the SL and DL do not satisfy their respective SL and DL thresholds, the UE 105 may select the transmission with the higher priority for performing in the slot (operation 8003A). Based on determining that both of the SL and DL satisfy their respective SL and DL thresholds, the UE 105 may obtain a measured metric over a measurement window (e.g., a pre-configured measurement time period) (operation 8003B). The measured metric may include a feedback ratio, an average CQI, and/or an average MCS. The measurement metric may be determined based on one or more previous SL transmissions and based on one or more previous DL transmissions. The UE 105 may select the transmission (e.g., either SL or DL) with the higher metric for performing in the slot (operation 8004). For example, the UE may determine a first measured metric based on one or more previous sidelink transmissions and may determine a second measured metric based on one or more previous downlink transmissions. The UE may determine the transmission type (e.g., SL or DL) having the higher priority for performing in the downlink slot based on whether the first measured metric is higher than the second measured metric.

FIG. 9 is a block diagram of an electronic device in a network environment 900, according to some embodiments of the present disclosure.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

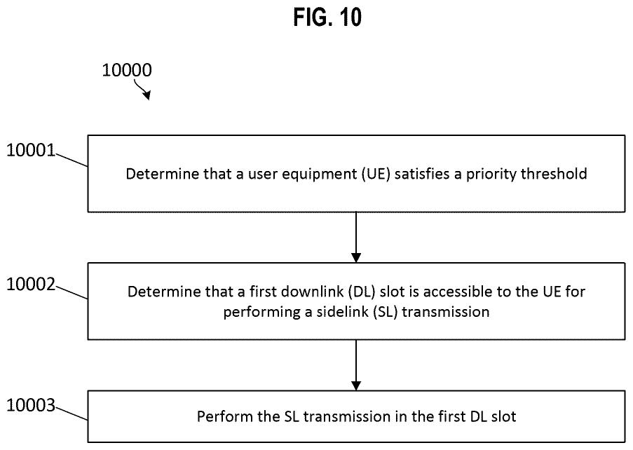

FIG. 10 is a flowchart depicting example operations of a method 10000 for performing sidelink communications, according to some embodiments of the present disclosure.

Referring to FIG. 10, the method 10000 may include one or more of the following operations. The UE 105, the network node 110, or another device (e.g., a second UE), may determine that the UE 105 satisfies a priority threshold (operation 10001). The UE 105, the network node 110, or another device may determine that a first downlink slot is accessible to the UE 105 for performing a sidelink transmission, based on the UE 105 satisfying the priority threshold (operation 10002). The UE 105 may perform the sidelink transmission in the first downlink slot (operation 10003).

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Thus, particular embodiments of the subject matter have been described herein.

Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for performing sidelink communications, the method comprising:
determining, by a user equipment (UE), based on a priority metric satisfying a first threshold and/or a channel-congestion metric satisfying a second threshold, that a first downlink slot within a subset of downlink slots is a candidate for a first sidelink transmission; and
performing, by the UE, the first sidelink transmission in the first downlink slot based on one or more transmission parameters, the transmission parameters being pre-configured or indicated to the UE.

2. The method of claim 1, wherein the determining of the priority metric satisfying the first threshold and/or the channel-congestion metric satisfying the second threshold comprises at least one of:
determining that communications associated with the UE qualify as ultra-reliable low latency communications (URLLC) traffic based on a pre-configured threshold indicated to the UE;
determining that the UE is of a source type associated with safety-related communications; or
determining that an occupancy of uplink slots accessible to the UE satisfies an occupancy threshold.

3. The method of claim 1, further comprising performing, by the UE or a second UE, a sidelink channel estimation for the first sidelink transmission based on a puncturing pattern indicating a subset of resource elements to be excluded from use for sidelink transmissions,
wherein the puncturing pattern is indicated by a bitmap or is pre-configured.

4. The method of claim 1, further comprising performing, by the UE or a second UE, a sidelink channel estimation, for the first sidelink transmission, with an altered pattern or density of a sidelink demodulation reference signal (SL DMRS) to avoid collisions with a downlink reference signal (DL RS).

5. The method of claim 1, further comprising determining that the subset of downlink slots is accessible to the UE for performing the first sidelink transmission by receiving, by the UE, a time division duplex (TDD) configuration indicating that the subset of downlink slots is available for performing the first sidelink transmission.

6. The method of claim 1, further comprising:
receiving, by the UE, a time division duplex (TDD) configuration; and
determining, by the UE, that only uplink slots are accessible to the UE for performing a second sidelink transmission.

7. The method of claim 6, wherein a first transmission parameter of the one or more transmission parameters differs from a second transmission parameter of the second sidelink transmission.

8. The method of claim 7, wherein the first transmission parameter indicates a limitation on a maximum transmit power of the UE.

9. The method of claim 1, further comprising performing, by the UE or a second UE, a signal strength measurement,
wherein the performing of the first sidelink transmission is scheduled on resources that are selected based on the signal strength measurement.

10. The method of claim 1, further comprising performing, by the UE, a channel-estimation procedure based on a sidelink demodulation reference signal (SL DMRS) pattern.

11. The method of claim 1, further comprising determining that the subset of downlink slots is accessible to the UE for performing the first sidelink transmission by determining that the first sidelink transmission has a higher priority than a first downlink transmission scheduled for the first downlink slot.

12. The method of claim 11, wherein the determining that the first sidelink transmission has the higher priority than the first downlink transmission comprises:
determining, by the UE, a first measured metric based on at least one previous sidelink transmission;
determining, by the UE, a second measured metric based on at least one previous downlink transmission; and
determining that the first measured metric is higher than the second measured metric.

13. The method of claim 12, wherein the determining of the first measured metric and the determining of the second measured metric are performed based on determining that both the first sidelink transmission and the first downlink transmission have priorities satisfying a threshold.

14. The method of claim 12, wherein the first measured metric and/or the second measured metric are measured based on a measurement window associated with the first downlink slot.

15. A system comprising:
a UE, the UE being configured to perform:
determining, based on a priority metric satisfying a first threshold and/or a channel-congestion metric satisfying a second threshold, that a first downlink slot within a subset of downlink slots is a candidate for a first sidelink transmission; and
the first sidelink transmission in the first downlink slot based on one or more transmission parameters, the one or more transmission parameters being pre-configured or indicated to the UE.

16. The system of claim 15, wherein the determining of the priority metric satisfying the first threshold and/or the channel-congestion metric satisfying the second threshold comprises at least one of:
determining that communications associated with the UE qualify as ultra-reliable low latency communications (URLLC) traffic based on a pre-configured threshold indicated to the UE;
determining that the UE is of a source type associated with safety-related communications; or
determining that an occupancy of uplink slots accessible to the UE satisfies an occupancy threshold.

17. The system of claim 15, wherein the UE is configured to perform a sidelink channel estimation for the first sidelink transmission based on a puncturing pattern indicating a subset of resource elements to be excluded from use for sidelink transmissions,
wherein the puncturing pattern is indicated by a bitmap or is pre-configured.

18. The system of claim 15, wherein the UE is configured to perform a sidelink channel estimation, for the first sidelink transmission, with an altered pattern or density of a sidelink demodulation reference signal (SL DMRS) to avoid collisions with a downlink reference signal (DL RS).

19. The system of claim 15, wherein the UE is configured to perform determining that the subset of downlink slots is accessible to the UE for performing the first sidelink transmission by receiving, by the UE, a time division duplex (TDD) configuration indicating that the subset of downlink slots is available for performing the first sidelink transmission.

20. A device comprising:
a processing circuit; and
a memory communicatively connected to the processing circuit, wherein the memory stores instructions that, based on being executed by the processing circuit, cause the processing circuit to perform:
determining, based on a priority metric satisfying a first threshold and/or a channel-congestion metric satisfying a second threshold, that a first downlink slot within a subset of downlink slots is a candidate for a first sidelink transmission; and
the first sidelink transmission in the first downlink slot based on one or more transmission parameters, the one or more transmission parameters being pre-configured or indicated to the device.
